(19) United States
(12) Patent Application Publication
(10) Pub. No.: US 2024/0349140 A1
(43) Pub. Date: Oct. 17, 2024

(54) METHODS, DEVICES, AND SYSTEMS FOR MODIFYING CANDIDATE CELLS FOR L1/L2 BASED INTER-CELL MOBILITY

(71) Applicant: ZTE Corporation, Shenzhen (CN)

(72) Inventors: Yingjun ZHOU, Shenzhen (CN); Yin GAO, Shenzhen (CN); Dapeng LI, Shenzhen (CN); Zijiang MA, Shenzhen (CN)

(73) Assignee: ZTE Corporation, Shenzhen (CN)

(21) Appl. No.: 18/749,964

(22) Filed: Jun. 21, 2024

Related U.S. Application Data
(63) Continuation of application No. PCT/CN2022/110676, filed on Aug. 5, 2022.

(51) Int. Cl. H04W 36/00

(52) U.S. Cl. CPC H04W 36/00835

(57) ABSTRACT

The present disclosure describes methods, system, and devices for modifying candidate cells for a layer 1 or layer 2 signaling (L1/L2) based inter-cell mobility. One method includes modifying, by a first network node, at least one candidate cell (CC) for an inter-cell mobility based on a measurement report by: receiving, by the first network node, the measurement report from a user equipment (UE); and sending, by the first network node, a CC modification message to a second network node, the CC modification message comprising a modified CC list based on the measurement report. Another method includes supporting modification of at least one CC for an inter-cell mobility based on a measurement report by: receiving a CC modification message from a first network node, the CC modification message comprising a modified CC list based on the measurement report that is received by the first network node from a UE.

### TECHNICAL FIELD

The present disclosure is directed generally to wireless communications. Particularly, the present disclosure relates to methods, devices, and systems for modifying candidate cells for a layer 1 or layer 2 signaling (L1/L2) based inter-cell mobility.

### BACKGROUND

Wireless communication technologies are moving the world toward an increasingly connected and networked society. High-speed and low-latency wireless communications rely on efficient network resource management and allocation between user equipment and wireless access network nodes (including but not limited to base stations). A new generation network is expected to provide high speed, low latency and ultra-reliable communication capabilities and fulfill the requirements from different industries and users.

Mobility is one of the important aspects in the rapid evolution of cellular mobile communication systems. There are many issues/problems associated with changing cells for user equipment (UE) moving from a cell boundary to another cell boundary. The issues/problems may include long latency, more signalling overhead, and/or long interruption time.

The present disclosure describes various embodiments for modifying candidate cells for a layer 1 or layer 2 signaling (L1/L2) based inter-cell mobility, addressing at least one of the issues/problems discussed above. Various embodiments in the present disclosure may achieve low latency, low overhead, and short interruption time, thus, improving the efficiency and/or performance of the wireless communication.

### SUMMARY

This document relates to methods, systems, and devices for wireless communication, and more specifically, for modifying candidate cells for a layer 1 or layer 2 signaling (L1/L2) based inter-cell mobility. Various embodiments in the present disclosure may increase the resource utilization efficiency, boost latency performance of the wireless communication, and/or conserve energy consumption of user equipment.

In one embodiment, the present disclosure describes a method for wireless communication. The method includes modifying, by a first network node, at least one candidate cell (CC) for an inter-cell mobility based on a measurement report by: receiving, by the first network node, the measurement report from a user equipment (UE); and sending, by the first network node, a CC modification message to a second network node, the CC modification message comprising a modified CC list based on the measurement report.

In one embodiment, the present disclosure describes a method for wireless communication. The method includes supporting, by a second network node, modification of at least one candidate cell (CC) for an inter-cell mobility based on a measurement report by: receiving, by the second network node, a CC modification message from a first network node, the CC modification message comprising a modified CC list based on the measurement report that is received by the first network node from a user equipment (UE).

In some other embodiments, an apparatus for wireless communication may include a memory storing instructions and a processing circuitry in communication with the memory. When the processing circuitry executes the instructions, the processing circuitry is configured to carry out the above methods.

In some other embodiments, a device for wireless communication may include a memory storing instructions and a processing circuitry in communication with the memory. When the processing circuitry executes the instructions, the processing circuitry is configured to carry out the above methods.

In some other embodiments, a computer-readable medium comprising instructions which, when executed by a computer, cause the computer to carry out the above methods.

The above and other aspects and their implementations are described in greater detail in the drawings, the descriptions, and the claims.

### BRIEF DESCRIPTION OF THE DRAWINGS

FIG. 1A shows a schematic diagram of a wireless communication system.

FIG. 1B shows a schematic diagram of a base station.

FIG. 2 shows an example of a network node.

FIG. 3 shows an example of a user equipment.

FIG. 4A shows a flow diagram of a method for wireless communication.

FIG. 4B shows a flow diagram of another method for wireless communication.

FIG. 5A shows a flow diagram of an exemplary embodiment for wireless communication.

FIG. 5B shows a flow diagram of another exemplary embodiment for wireless communication.

FIG. 6A shows a flow diagram of an exemplary embodiment for wireless communication.

FIG. 6B shows a flow diagram of another exemplary embodiment for wireless communication.

FIG. 7A shows a flow diagram of an exemplary embodiment for wireless communication.

FIG. 7B shows a flow diagram of another exemplary embodiment for wireless communication.

FIG. 7C shows a flow diagram of an exemplary embodiment for wireless communication.

FIG. 7D shows a flow diagram of another exemplary embodiment for wireless communication.

FIG. 8 shows a flow diagram of an exemplary embodiment for wireless communication.

FIG. 9 shows a flow diagram of another exemplary embodiment for wireless communication.

### DETAILED DESCRIPTION

The present disclosure will now be described in detail hereinafter with reference to the accompanied drawings, which form a part of the present disclosure, and which show, by way of illustration, specific examples of embodiments. Please note that the present disclosure may, however, be embodied in a variety of different forms and, therefore, the covered or claimed subject matter is intended to be construed as not being limited to any of the embodiments to be set forth below.

Throughout the specification and claims, terms may have nuanced meanings suggested or implied in context beyond an explicitly stated meaning. Likewise, the phrase “in one embodiment” or “in some embodiments” as used herein does not necessarily refer to the same embodiment and the phrase “in another embodiment” or “in other embodiments” as used herein does not necessarily refer to a different embodiment. The phrase “in one implementation” or “in some implementations” as used herein does not necessarily refer to the same implementation and the phrase “in another implementation” or “in other implementations” as used herein does not necessarily refer to a different implementation. It is intended, for example, that claimed subject matter includes combinations of exemplary embodiments or implementations in whole or in part.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” or “at least one” as used herein, depending at least in part upon context, may be used to describe any feature, structure, or characteristic in a singular sense or may be used to describe combinations of features, structures or characteristics in a plural sense. Similarly, terms, such as “a”, “an”, or “the”, again, may be understood to convey a singular usage or to convey a plural usage, depending at least in part upon context. In addition, the term “based on” or “determined by” may be understood as not necessarily intended to convey an exclusive set of factors and may, instead, allow for existence of additional factors not necessarily expressly described, again, depending at least in part on context.

The present disclosure describes various embodiments for modifying candidate cells for a layer 1 or layer 2 signaling (L1/L2) based inter-cell mobility.

Wireless communication technologies are moving the world toward an increasingly connected and networked society. High-speed and low-latency wireless communications rely on efficient network resource management and allocation between user equipment and wireless access network nodes (including but not limited to base stations). A new generation network is expected to provide high speed, low latency and ultra-reliable communication capabilities and fulfill the requirements from different industries and users. Mobility is one of the important aspects in the rapid evolution of cellular mobile communication systems. There are many issues/problems associated with changing cells for user equipment (UE) moving from a cell boundary to another cell boundary. The issues/problems may include long latency, more signalling overhead, and/or long interruption time.

For example, in some implementations, a serving cell change may be triggered by a layer 3 (L3) measurements and may be done by a radio resource control (RRC) signalling triggered reconfiguration with synch for change of primary cell (PCell) and primary secondary cell (PSCell), as well as release and add for secondary cells (SCells) when applicable. These implementation may include complete L2 (and/or L1) resets, resulting in more latency, more signalling overhead, and/or more interruption time than beam switch mobility. In some implementations, during the L1/L2 mobility candidate cell configuration phase between central unit (CU) and distributed unit (DU), the DU may be unable to adjust the candidate cell list dynamically based on L1 measurement report.

Various embodiments in the present disclosure include the procedure and signalling to let DU adjust the candidate cell configuration dynamically based on L1 measurement report during the candidate cell configuration phase. Various embodiments in the present disclosure may achieve low latency, low overhead, and short interruption time, thus, improving the efficiency and/or performance of the wireless communication.

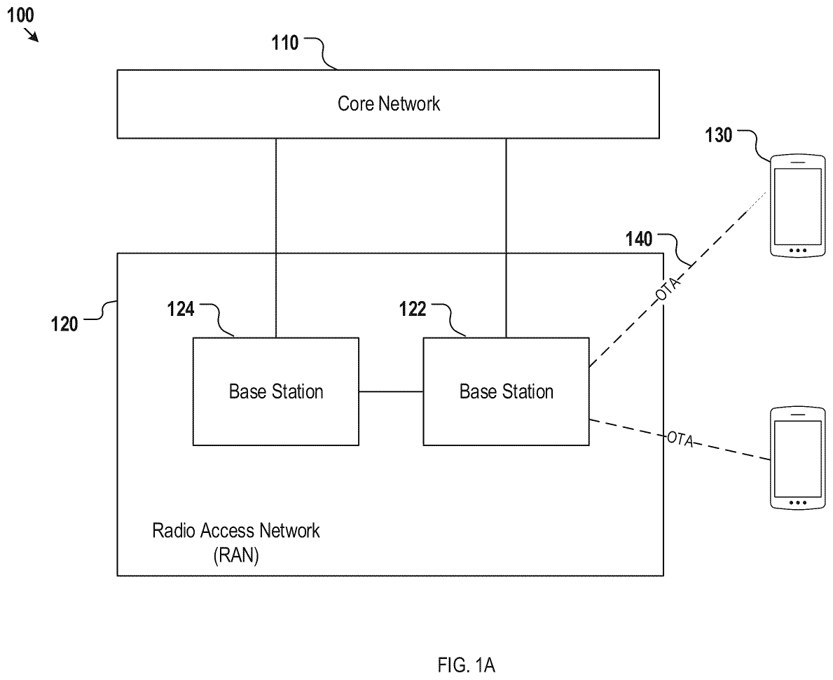

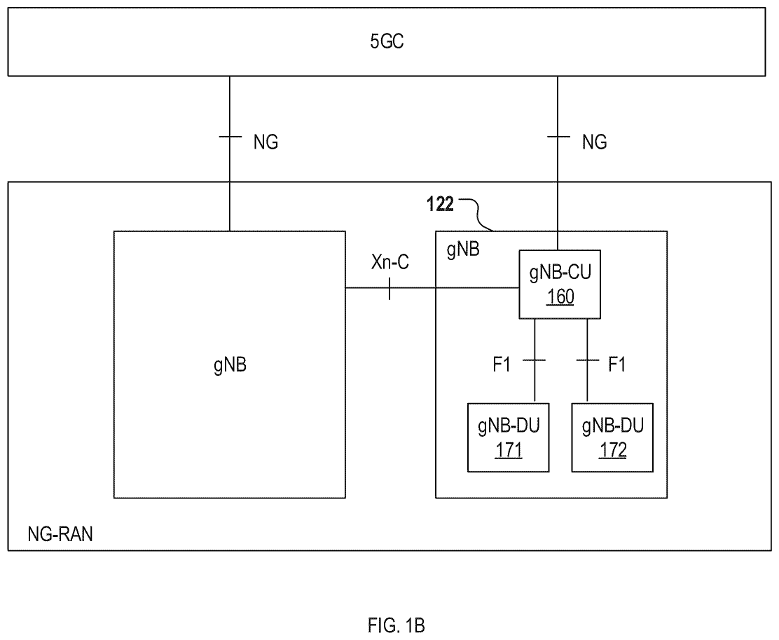

FIG. 1A shows an example cellular wireless communication network 100 (also referred to as wireless communication system) that includes a core network 110, a radio access network (RAN) 120, and one or more user equipment (UE) 130.

The RAN 120 further includes multiple base stations 122 and 124. The base station 122 and one or more user equipment (UE) 130 communicate with one another via Over the Air (OTA) radio communication resources 140. The wireless communication network 100 may be implemented as, as for example, a 2G, 3G, 4G/LTE, 5G, or 6G cellular communication network. Correspondingly, the base stations 122 and 124 may be implemented as a 2G base station, a 3G nodeB, an LTE eNB, or a 5G New Radio (NR) gNB. The UE 130 may be implemented as mobile or fixed communication devices for accessing the wireless communication network 100. The one or more UE 130 may include but is not limited to mobile phones, Internet of Things (IoT) devices, Machine-type communications (MTC) devices, laptop computers, tablets, personal digital assistants, wearable devices, distributed remote sensor devices, roadside assistant equipment, and desktop computers. Alternative to the context of cellular wireless network, the RAN 120 and the principles described below may be implemented as other types of radio access networks, such as Wi-Fi, Bluetooth, ZigBee, and WiMax networks.

In the example wireless communication system 100 of FIG. 1A, the one or more UE 130 may connect with and establish a communication session with the base station 122 via the OTA interface 140. The communication session between the UE 130 and the base station 122 may utilize downlink (DL) and/or uplink (UL) transmission resources. The DL transmission resource carries data from the base station 122 to the UE 130, and the UL transmission resource carries data from the UE 130 to the base station 122. Under certain circumstances, for example when the base station 122 is unavailable or when the UE 130 moves into a coverage of the base station 124, the one or more UE 130 may connect with and establish a communication session with the base station 122.

Referring to FIG. 1B, a base station (e.g., gNB) 122 may have a control-distributed separated structure, which may include a control unit (CU) 160 and one or more distributed unit (DU) 171 and/or 172. The 5GC may communicate with the gNB via a NG interface between them. The gNB and another gNB may communicate via a Xn-C interface. The gNB-CU may communicate with the one or more gNB-DU via a F1 interface.

In some implementations, in the architecture of CU/DU split, the gNB-CU is defined as a logical node hosting RRC, SDAP and PDCP protocols of the gNB or RRC and PDCP protocols of the en-gNB that controls the operation of one or more gNB-DUs. The gNB-DU is defined as a logical node hosting RLC, MAC and PHY layers of the gNB or en-gNB, and its operation is partly controlled by gNB-CU. One gNB-DU supports one or multiple cells. One cell is supported by only one gNB-DU.

In some implementations, to reduce handover interruption time and improve mobility reliability (i.e. mobility robust), a conditional handover (CHO) may be promoted. CHO is defined as a handover that is executed by the UE when execution condition(s) is met. The UE starts evaluating the execution condition(s) upon receiving the CHO configuration, and stops evaluating the execution condition(s) once handover is triggered. The CHO configuration includes the candidate PCell configuration generated by the candidate target node and the corresponding execution condition(s) for candidate cell.

In some implementations, to improve mobility reliability (i.e. mobility robust) in case of SN change or SN addition, a conditional PSCell addition/change (CPAC) may be promoted. Similar to CHO, CPAC is defined as having a configured CPAC execution condition that determines when/whether the corresponding PSCell addition/change command is executed. Upon receiving the CPAC configuration, a UE starts to evaluate the condition and only executes the CPAC command once the condition is met.

In some implementations, to reduce mobility interruption, a dual active protocol stack (DAPS) based handover procedure may be promoted. In the DAPS based handover procedure, the UE keeps simultaneous connection with the source cell and target cell until releasing the source cell after successful random access to the target cell.

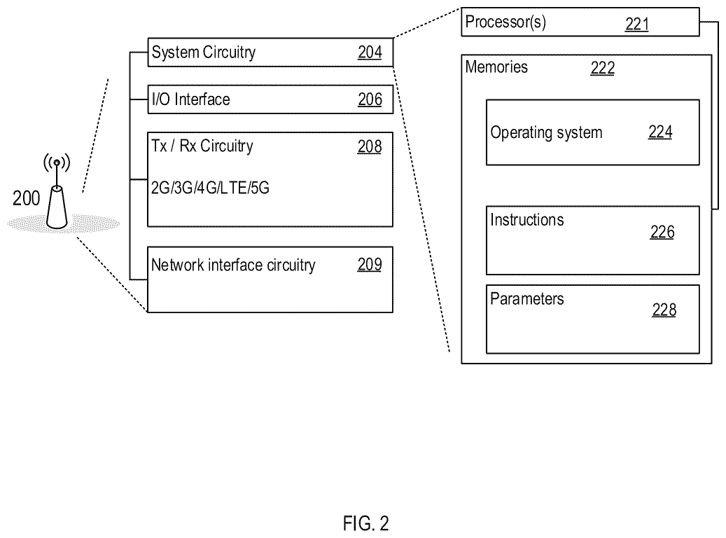

FIG. 2 shows an example of electronic device 200 to implement a network base station. The example electronic device 200 may include radio transmitting/receiving (Tx/Rx) circuitry 208 to transmit/receive communication with UEs and/or other base stations. The electronic device 200 may also include network interface circuitry 209 to communicate the base station with other base stations and/or a core network, e.g., optical or wireline interconnects, Ethernet, and/or other data transmission mediums/protocols. The electronic device 200 may optionally include an input/output (I/O) interface 206 to communicate with an operator or the like.

The electronic device 200 may also include system circuitry 204. System circuitry 204 may include processor(s) 221 and/or memory 222. Memory 222 may include an operating system 224, instructions 226, and parameters 228. Instructions 226 may be configured for the one or more of the processors 124 to perform the functions of the network node. The parameters 228 may include parameters to support execution of the instructions 226. For example, parameters may include network protocol settings, bandwidth parameters, radio frequency mapping assignments, and/or other parameters.

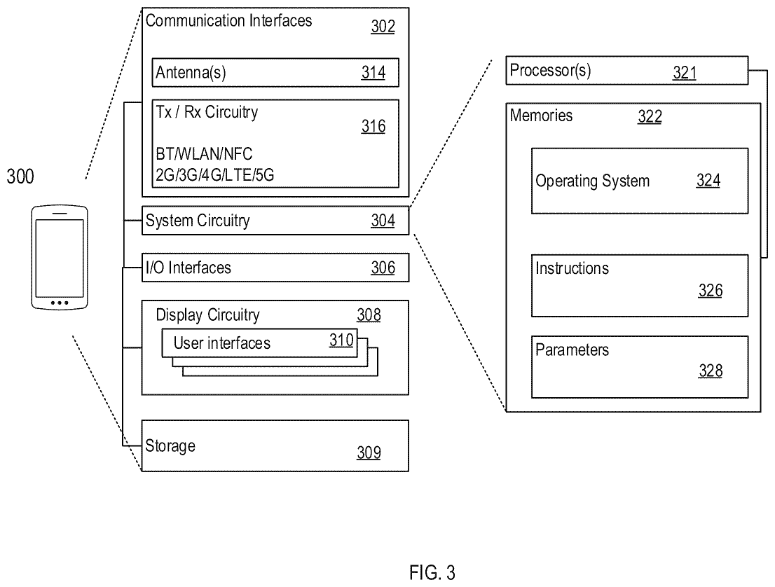

FIG. 3 shows an example of an electronic device to implement a terminal device 300 (for example, user equipment (UE)). The UE 300 may be a mobile device, for example, a smart phone or a mobile communication module disposed in a vehicle. The UE 300 may include communication interfaces 302, a system circuitry 304, an input/output interfaces (I/O) 306, a display circuitry 308, and a storage 309. The display circuitry may include a user interface 310. The system circuitry 304 may include any combination of hardware, software, firmware, or other logic/circuitry. The system circuitry 304 may be implemented, for example, with one or more systems on a chip (SoC), application specific integrated circuits (ASIC), discrete analog and digital circuits, and other circuitry. The system circuitry 304 may be a part of the implementation of any desired functionality in the UE 300. In that regard, the system circuitry 304 may include logic that facilitates, as examples, decoding and playing music and video, e.g., MP3, MP4, MPEG, AVI, FLAC, AC3, or WAV decoding and playback; running applications; accepting user inputs; saving and retrieving application data; establishing, maintaining, and terminating cellular phone calls or data connections for, as one example, internet connectivity; establishing, maintaining, and terminating wireless network connections, Bluetooth connections, or other connections; and displaying relevant information on the user interface 310. The user interface 310 and the inputs/output (I/O) interfaces 306 may include a graphical user interface, touch sensitive display, haptic feedback or other haptic output, voice or facial recognition inputs, buttons, switches, speakers and other user interface elements. Additional examples of the I/O interfaces 306 may include microphones, video and still image cameras, temperature sensors, vibration sensors, rotation and orientation sensors, headset and microphone input/output jacks, Universal Serial Bus (USB) connectors, memory card slots, radiation sensors (e.g., IR sensors), and other types of inputs.

Referring to FIG. 3, the communication interfaces 302 may include a Radio Frequency (RF) transmit (Tx) and receive (Rx) circuitry 316 which handles transmission and reception of signals through one or more antennas 314. The communication interface 302 may include one or more transceivers. The transceivers may be wireless transceivers that include modulation/demodulation circuitry, digital to analog converters (DACs), shaping tables, analog to digital converters (ADCs), filters, waveform shapers, filters, pre-amplifiers, power amplifiers and/or other logic for transmitting and receiving through one or more antennas, or (for some devices) through a physical (e.g., wireline) medium. The transmitted and received signals may adhere to any of a diverse array of formats, protocols, modulations (e.g., QPSK, 16-QAM, 64-QAM, or 256-QAM), frequency channels, bit rates, and encodings. As one specific example, the communication interfaces 302 may include transceivers that support transmission and reception under the 2G, 3G, BT, WiFi, Universal Mobile Telecommunications System (UMTS), High Speed Packet Access (HSPA)+, 4G/Long Term Evolution (LTE), 5G standards, and/or 6G standards. The techniques described below, however, are applicable to other wireless communications technologies whether arising from the 3rd Generation Partnership Project (3GPP), GSM Association, 3GPP2, IEEE, or other partnerships or standards bodies.

Referring to FIG. 3, the system circuitry 304 may include one or more processors 321 and memories 322. The memory 322 stores, for example, an operating system 324, instructions 326, and parameters 328. The processor 321 is configured to execute the instructions 326 to carry out desired functionality for the UE 300. The parameters 328 may provide and specify configuration and operating options for the instructions 326. The memory 322 may also store any BT, WiFi, 3G, 4G, 5G, 6G, or other data that the UE 300 will send, or has received, through the communication interfaces 302. In various implementations, a system power for the UE 300 may be supplied by a power storage device, such as a battery or a transformer.

The present disclosure describes various embodiment for modifying candidate cells for a layer 1 or layer 2 signaling (L1/L2) based inter-cell mobility, which may be implemented, partly or totally, on the network base station and/or the user equipment described above in FIGS. 2-3.

In various embodiment, the L1/L2 based inter-cell mobility may belong to an intra-DU inter-cell mobility, wherein a UE moves from a first cell to a second cell, and both the first and second cells are within a same gNB-DU.

In various embodiment, the L1/L2 based inter-cell mobility may belong to an inter-DU inter-cell mobility, wherein a UE moves from a first cell or cells in a first gNB-DU to a second cell or cells in a second gNB-DU, and the first gNB-DU and the second gNB-DU are within a same gNB-CU.

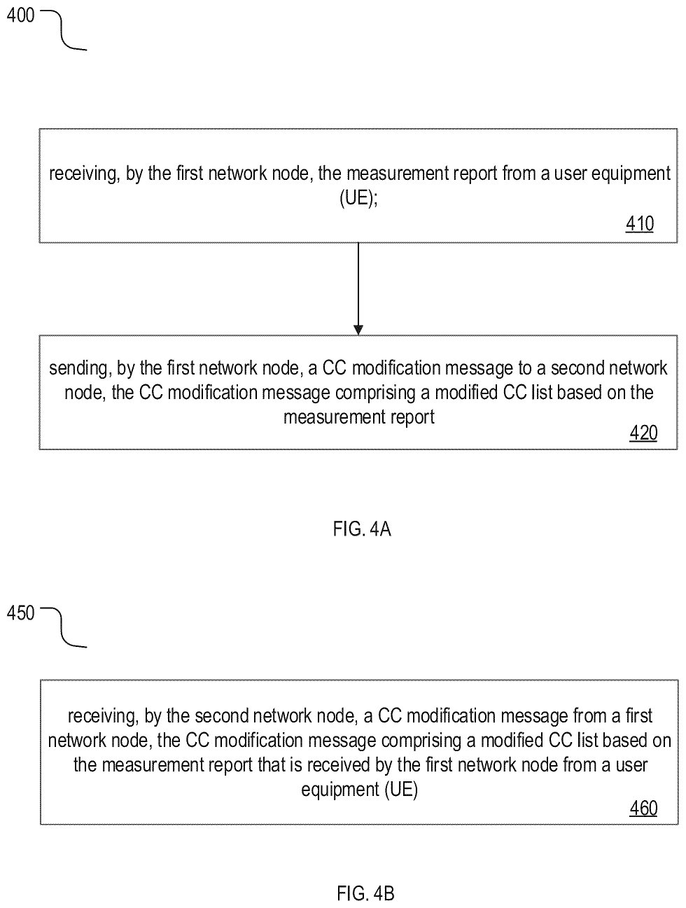

Referring to FIG. 4A, the present disclosure describes various embodiments of a method 400 for wireless communication including modifying, by a first network node, at least one candidate cell (CC) for an inter-cell mobility based on a measurement report. The method 400 may include a portion or all of the following steps: step 410, receiving, by the first network node, the measurement report from a user equipment (UE); and/or step 420, sending, by the first network node, a CC modification message to a second network node, the CC modification message comprising a modified CC list based on the measurement report.

Referring to FIG. 4B, the present disclosure describes various embodiments of a method 450 for wireless communication including supporting, by a second network node, modification of at least one candidate cell (CC) for an inter-cell mobility based on a measurement report. The method 450 may include step 460, receiving, by the second network node, a CC modification message from a first network node, the CC modification message comprising a modified CC list based on the measurement report that is received by the first network node from a user equipment (UE).

In various embodiments and/or implementations of the present disclosure, a network node may be referred as a network element.

In some implementations, in addition to a portion or all of the other implementation(s) or embodiment(s) described in the present disclosure, in response to the inter-cell mobility belonging to an intra-distributed unit (intra-DU) inter-cell mobility, the first network node comprises a distributed unit of a base station (gNB-DU); in response to the inter-cell mobility belonging to an inter-distributed unit (inter-DU) inter-cell mobility, the first network node comprises a source gNB-DU; and/or the second network node a control unit of the base station (gNB-CU).

In some implementations, in addition to a portion or all of the other implementation(s) or embodiment(s) described in the present disclosure, the inter-cell mobility comprises a layer 1 or layer 2 signaling based mobility (L1/L2 mobility); and/or the measurement report comprises a L1 measurement report.

In some implementations, in addition to a portion or all of the other implementation(s) or embodiment(s) described in the present disclosure, the CC modification message comprises a modified CC configuration corresponding to the modified CC list; and/or the first network node sends a second message to the second network node, the second message comprising the modified CC configuration corresponding to the modified CC list.

In some implementations, in addition to a portion or all of the other implementation(s) or embodiment(s) described in the present disclosure, the CC modification message belongs to an F1 interface message; and/or the modified CC list comprises at least one of the following: a to-be-cancelled CC list, a to-be-added CC list, a DU-suggested CC list.

In some implementations, in addition to a portion or all of the other implementation(s) or embodiment(s) described in the present disclosure, the F1 interface message comprises at least one of the following: a UE context release request message, a UE context modification required message, or a UE context modification response message.

In some implementations, in addition to a portion or all of the other implementation(s) or embodiment(s) described in the present disclosure, the inter-cell mobility belongs to an intra-DU inter-cell mobility; in response to receiving the CC modification message from the first network node, the second network node sends a modified RRCReconfiguration message to the first network node, the modified RRCReconfiguration message comprising a modified CC configuration based on the modified CC list; the first network node forwards the modified RRCReconfiguration message to the UE; and/or the first network receives a modified RRCReconfigurationComplete message from the UE and forwards the modified RRCReconfigurationComplete message to the second network node.

In some implementations, in addition to a portion or all of the other implementation(s) or embodiment(s) described in the present disclosure, before the first network node receives the measurement report from the UE: the first network node receives a CU-suggested CC list from the second network node; and/or the first network node sends an accepted CC list and accepted CC configuration corresponding to the accepted CC list to the second network node.

In some implementations, in addition to a portion or all of the other implementation(s) or embodiment(s) described in the present disclosure, before the first network node receives the measurement report from the UE: in response to receiving the accepted CC configuration from the first network node, the second network node sends an accepted RRCReconfiguration message to the first network node, the accepted RRCReconfiguration message comprising the accepted CC configuration; the first network node forwards the accepted RRCReconfiguration message to the UE; and/or the first network receives an accepted RRCReconfigurationComplete message from the UE and forwards the accepted RRCReconfigurationComplete message to the second network node.

In some implementations, in addition to a portion or all of the other implementation(s) or embodiment(s) described in the present disclosure, the first network node receives an initial measurement report from the UE; in response to receiving the CU-suggested CC list from the second network node, the first network node sends an accepted CC list, a DU-suggested CC list, and their corresponding CC configuration to the second network node, wherein the accepted CC list and the DU-suggested CC list are based on the CU-suggested CC list and the initial measurement report; the second network node sends an accepted RRCReconfiguration message to the first network node, the accepted RRCReconfiguration message comprising accepted CC configuration; the first network node forwards the accepted RRCReconfiguration message to the UE; and/or the first network receives an accepted RRCReconfigurationComplete message from the UE and forwards the accepted RRCReconfigurationComplete message to the second network node.

In some implementations, in addition to a portion or all of the other implementation(s) or embodiment(s) described in the present disclosure, the modified CC list comprises a to-be-cancelled CC list; the CC modification message comprises a UE context release request message; and/or the first network node sends a modified CC configuration corresponding to the modified CC list to the second network node.

In some implementations, in addition to a portion or all of the other implementation(s) or embodiment(s) described in the present disclosure, the modified CC list comprises a to-be-added CC list; and/or the first network node sends a modified CC configuration corresponding to the modified CC list to the second network node;

In some implementations, in addition to a portion or all of the other implementation(s) or embodiment(s) described in the present disclosure, when the CC modification message comprises a UE context modification required message, the first network node receives a confirmation message from the second network node.

In some implementations, in addition to a portion or all of the other implementation(s) or embodiment(s) described in the present disclosure, when the CC modification message comprises an access success message, the second network node does not need send a response message to the first network node, so that the first network node does not receive a confirmation message from the second network node.

In some implementations, in addition to a portion or all of the other implementation(s) or embodiment(s) described in the present disclosure, the CC modification message comprises the modified CC configuration; and/or the first network node sends a second message to the second network node, the second message comprising the modified CC configuration.

In some implementations, in addition to a portion or all of the other implementation(s) or embodiment(s) described in the present disclosure, the inter-cell mobility belongs to an intra-CU inter-DU inter-cell mobility between the first network node and a third network node; in response to receiving the CC modification message from the first network node, the second network node sends a modified RRCReconfiguration message to the first network node, the modified RRCReconfiguration message comprising a modified CC configuration based on the modified CC list; the first network node forwards the modified RRCReconfiguration message to the UE; and/or the first network receives a modified RRCReconfigurationComplete message from the UE and forwards the modified RRCReconfigurationComplete message to the second network node.

In some implementations, in addition to a portion or all of the other implementation(s) or embodiment(s) described in the present disclosure, the third network node comprises a candidate gNB-DU.

In various embodiments/implementations of the present disclosure, the candidate gNB-DU (or referred as the candidate DU) may be referred as the target gNB-DU (or referred as the target DU).

In some implementations, in addition to a portion or all of the other implementation(s) or embodiment(s) described in the present disclosure, before the first network node receives the measurement report from the UE: the third network node receives a CU-suggested CC list from the second network node; and/or the third network node sends an accepted CC list and accepted CC configuration corresponding to the accepted CC list to the second network node.

In some implementations, in addition to a portion or all of the other implementation(s) or embodiment(s) described in the present disclosure, before the first network node receives the measurement report from the UE: the second network node sends a second F1 interface message to the first network node, the second F1 interface message comprising a configured CC list; and/or in response to receiving the second F1 interface message, the first network node sends a response message to the second network node.

In some implementations, in addition to a portion or all of the other implementation(s) or embodiment(s) described in the present disclosure, before the first network node receives the measurement report from the UE: the second network node sends an accepted RRCReconfiguration message to the first network node, the accepted RRCReconfiguration message comprising the accepted CC configuration; the first network node forwards the accepted RRCReconfiguration message to the UE; and/or the first network receives an accepted RRCReconfigurationComplete message from the UE and forwards the accepted RRCReconfigurationComplete message to the second network node.

In some implementations, in addition to a portion or all of the other implementation(s) or embodiment(s) described in the present disclosure, the first network node receives an initial measurement report from the UE; in response to receiving the CU-suggested CC list from the second network node, the first network node sends at least one of the following: an accepted CC list, a DU-suggested CC list, and their corresponding CC configuration, to the second network node, wherein the accepted CC list and the DU-suggested CC list are based on the CU-suggested CC list and the initial measurement report; the second network node sends an accepted RRCReconfiguration message to the first network node, the accepted RRCReconfiguration message comprising accepted CC configuration; the first network node forwards the accepted RRCReconfiguration message to the UE; and/or the first network receives an accepted RRCReconfigurationComplete message from the UE and forwards the accepted RRCReconfigurationComplete message to the second network node.

In some implementations, in addition to a portion or all of the other implementation(s) or embodiment(s) described in the present disclosure, the modified CC list comprises a to-be-cancelled CC list; and/or the CC modification message comprises a UE context release request message.

In some implementations, in addition to a portion or all of the other implementation(s) or embodiment(s) described in the present disclosure, the modified CC list comprises a to-be-added CC list; the CC modification message comprises a UE context modification required message; the first network node sends a modified CC configuration corresponding to the modified CC list to the second network node; and/or the first network node receives a confirmation message from the second network node.

In some implementations, in addition to a portion or all of the other implementation(s) or embodiment(s) described in the present disclosure, the CC modification message comprises the modified CC configuration; and/or the first network node sends a second message to the second network node, the second message comprising the modified CC configuration.

In some implementations, in addition to a portion or all of the other implementation(s) or embodiment(s) described in the present disclosure, at least one of the accepted RRCReconfiguration message or the modified RRCReconfiguration message is transmitted via a DL RRC message transfer message from the second network node to the first network node; and/or at least one of the accepted RRCReconfigurationComplete message or the modified RRCReconfigurationComplete message is transmitted via a UL RRC message transfer message from the first network node to the second network node.

The present disclosure describes various embodiments with non-limiting exemplary examples for supporting a layer 1 or layer 2 signaling (L1/L2) based inter-cell mobility. For a non-limiting example, a DU (e.g., a source DU) may determine the candidate cell(s) to be modified, including but not limited to, canceled/removed/added/newly-suggested, based on the L1 measurement report from a UE. The DU may send the candidate cell to be canceled/added/suggested list and the generated candidate cell configuration (e.g. CellGroupConfig) to the CU via F1 interface message (e.g. a UE context release request message for release, a UE context modification required message for addition, a UE context modification response message for suggestion, or other message).

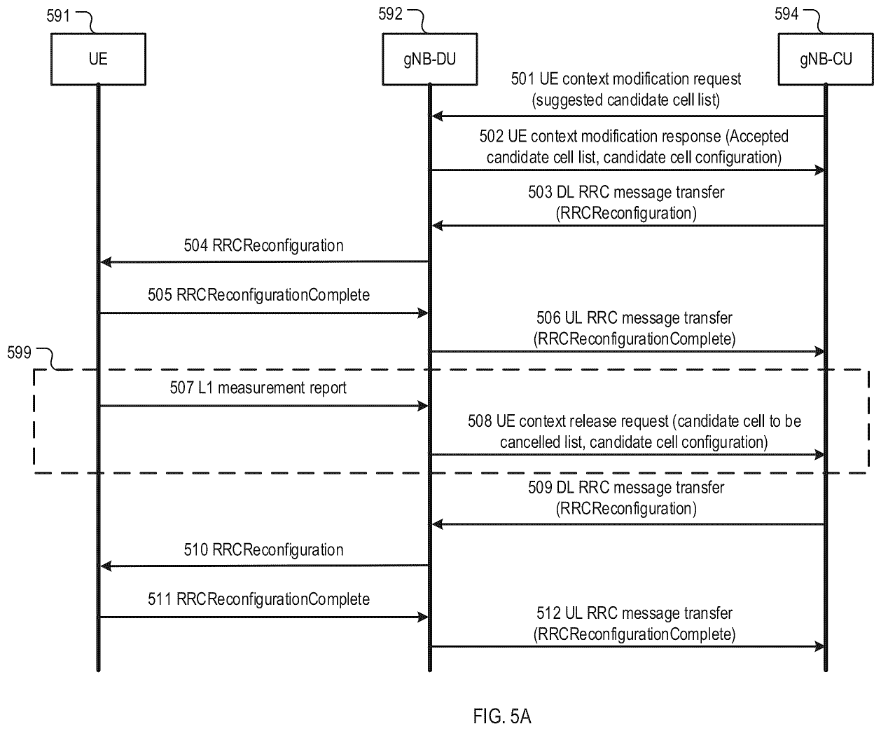

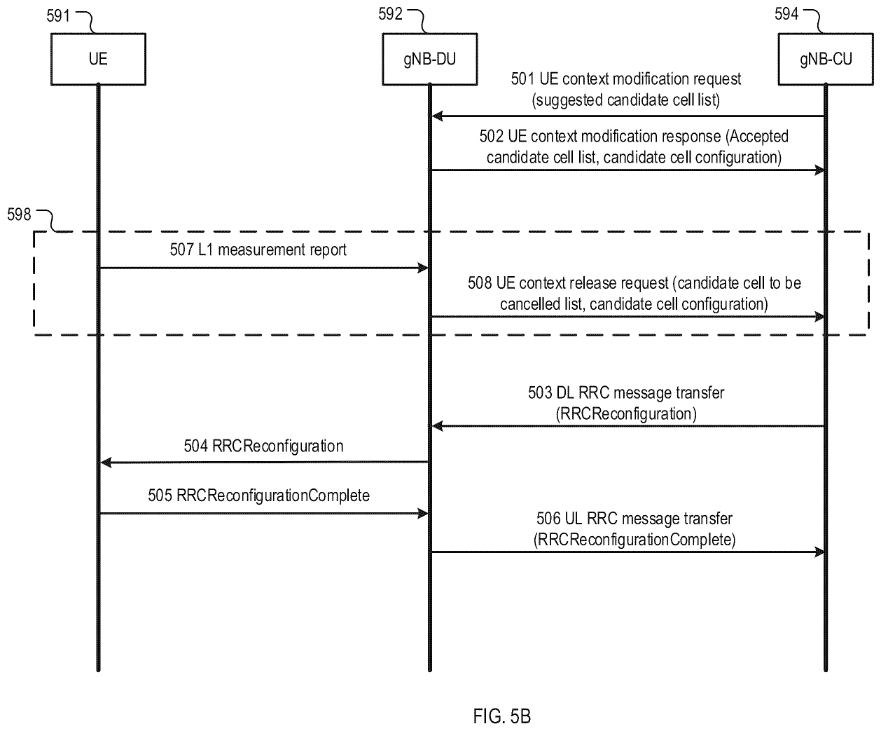

FIG. 5A shows one exemplary embodiment for modifying candidate cells for a L1/L2 based intra-DU inter-cell mobility, wherein a UE 591 may move from first cell(s) operated by a gNB-DU 592 to second cell(s) operated by the same gNB-DU 592. In some implementations, the gNB-DU may communicate with a gNB-CU 594, which can be referred as intra-CU intra-DU inter-cell mobility. The exemplary embodiment may include a portion or all of the following steps. The following steps are labeled with step numbers, which are used for labeling the steps and do not impose any limitation on the order/sequence of the steps.

Referring to step 501, the gNB-CU (or referred as “CU”) determines a list of candidate cell (or referred as suggested candidate cell list), e.g. according to the RRM measurements. The CU sends the suggested candidate cell list to the gNB-DU (or referred as “DU”) via a F1 interface message (e.g. UE CONTEXT MODIFICATION REQUEST message or other message), to request the DU to set up candidate cells. The message may also include an indication to indicate that the procedure is for L1/L2 mobility, and/or an indication to indicate that the procedure is for which type of L1/L2 mobility.

Referring to step 502, the DU determine whether to set up the candidate cells as suggested, and sends the generated candidate cell configuration (e.g. CellGroupConfig) to the CU, e.g. via UE CONTEXT MODIFICATION RESPONSE message. When the DU fails to set up some candidate cells, the DU may also include an accepted cell list (e.g. including a list of cells that have been successfully set up) or a failed/rejected cell list (e.g. including a list of cells that fail to set up) in the message. The DU may also include the generated triggering events/execution conditions in the message (e.g. for UE or CU triggered mobility).

Referring to step 503, the CU sends the generated RRCReconfiguration message to the DU, e.g. via a DL RRC MESSAGE TRANSFER message. The RRC message includes the candidate cell configuration, and may also include the triggering events/conditions associated with the candidate cell(s) (e.g., for UE triggered mobility).

Referring to step 504, the DU forwards the received RRCReconfiguration message to the UE.

Referring to steps 505 and 506, the UE responds to the DU with an RRCReconfigurationComplete message, for which the DU forwards to the CU, e.g. via an UL RRC MESSAGE TRANSFER message.

Referring to step 507, the UE sends a L1 measurement report to the DU.

Referring to step 508, the DU determines the candidate cell(s) to be canceled. The DU sends the candidate cell to be canceled list and the generated candidate cell configuration (e.g. CellGroupConfig) to the CU via a F1 interface message (e.g. UE context release request message or other message).

In some implementations, the F1 interface message may include a UE context release request message. The UE context release request message may belong to a class 2 message, which does not require the message receiver to send a response message to the message sender. When the CU receives the UE context release request message from the DU, the CU does not need to send the DU a response message in response to the UE context release request message.

Steps 509, 510, 511, and 512 may be similarly performed as steps 503, 504, 505, and 506, respectively.

Steps 507 and 508, referred as 599, describes implementations, wherein the DU determines the to-be-cancelled candidate cell list based on the L1 measurement report received from the UE, and the DU sends the to-be-cancelled candidate cell list to the CU via a F1 interface message.

In some other implementations, referring to FIG. 5B, the steps 507 and 508, referred as 598, may be performed between step 502 and step 503, wherein the DU receives a L1 measurement report from the UE after step 502 and determines the candidate cell(s) to be canceled, and the DU sends the to-be-cancelled candidate cell list to the CU via a F1 interface message.

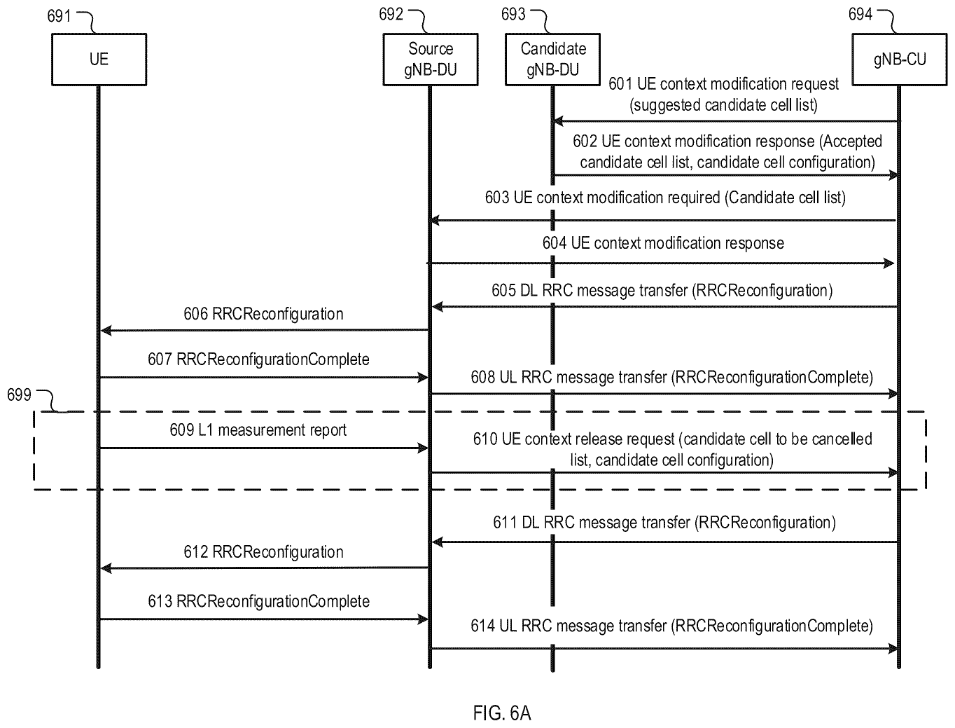

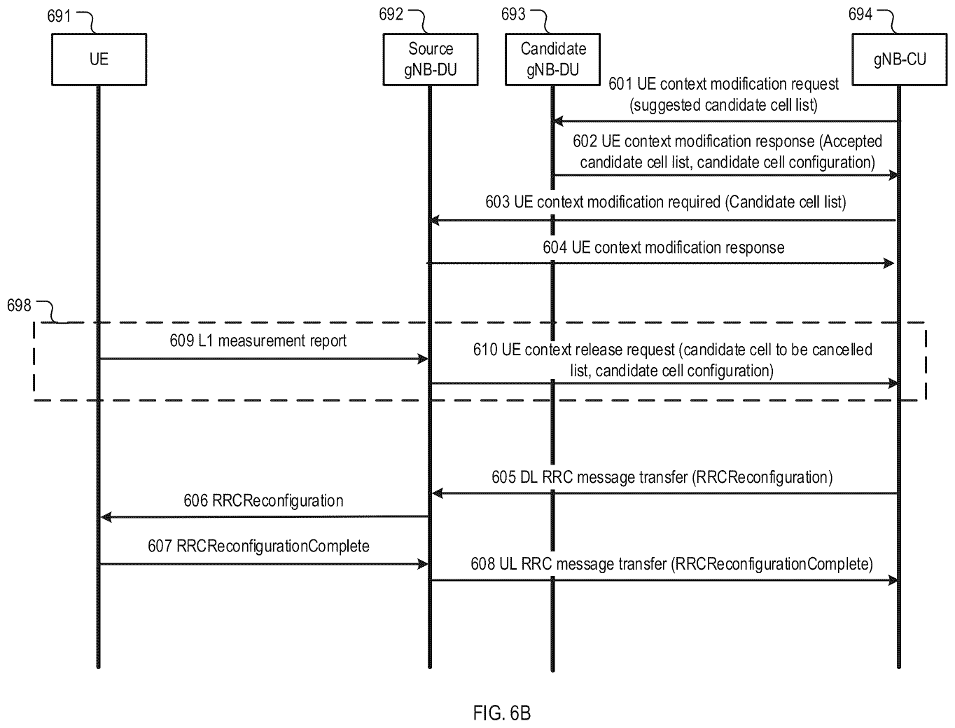

FIG. 6A shows another exemplary embodiment for modifying candidate cells for a L1/L2 based inter-DU inter-cell mobility, wherein a UE 691 may move from a cell operated by a source gNB-DU 692 to another cell operated by a candidate gNB-DU 693. In some implementations, the source gNB-DU and the candidate gNB-DU may communicate with a same gNB-CU 694, which can be referred as intra-CU inter-DU inter-cell mobility. The exemplary embodiment may include a portion or all of the following steps. The following steps are labeled with step numbers, which are used for labeling the steps and do not impose any limitation on the order/sequence of the steps.

Referring to step 601, the gNB-CU (or referred as “CU”) determines the candidate cell, e.g. according to the RRM measurements. The CU sends a suggested candidate cell list to the candidate gNB-DU (or referred as “candidate DU”) via a F1 interface message (e.g. UE CONTEXT SETUP REQUEST message or other message), to request the candidate DU to set up candidate cells. The message may also include an indication to indicate that the procedure is for L1/L2 mobility, and/or an indication to indicate that the procedure is for which type of L1/L2 mobility.

In the present disclosure, in various embodiments/implementations, the candidate gNB-DU may be referred as the candidate gNB-DU.

Referring to step 602, the candidate gNB-DU may determine whether to set up the candidate cells as suggested, and sends the generated candidate cell configuration (e.g. CellGroupConfig) to the CU, e.g. via UE CONTEXT SETUP RESPONSE message. When the candidate DU fails to set up some candidate cells, the candidate DU may also include a accepted cell list (e.g. including a list of cells that have been successfully set up) and/or a failed/rejected cell list (e.g. including a list of cells that fail to set up) in the message.

Referring to step 603, the CU sends the configured candidate cell list to the source gNB-DU (or referred as source DU) via a F1 interface message, e.g. a UE context modification request message. This message may also include the CU generated triggering events/execution conditions (e.g. for DU triggered mobility).

Referring to step 604, the source DU responses with an UE context modification response message. This message may also include the DU generated triggering events/execution conditions (e.g. for UE triggered mobility or CU triggered mobility).

Steps 605, 606, 607, 608, 609, 610, 611, 612, 613, and 614 may be performed similarly as steps 503, 504, 505, 506, 507, 508, 509, 510, 511, and 512, respectively.

Steps 609 and 610, referred as 699, describes implementations, wherein the source DU determines the to-be-cancelled candidate cell list based on the L1 measurement report received from the UE, and the source DU sends the to-be-cancelled candidate cell list to the CU via a F1 interface message.

In some other implementations, referring to FIG. 6B, the steps 609 and 610, referred as 698, may be performed between step 604 and step 605, wherein the source DU receives a L1 measurement report from the UE after step 604 and determines the candidate cell(s) to be canceled, and the source DU sends the to-be-cancelled candidate cell list to the CU via a F1 interface message.

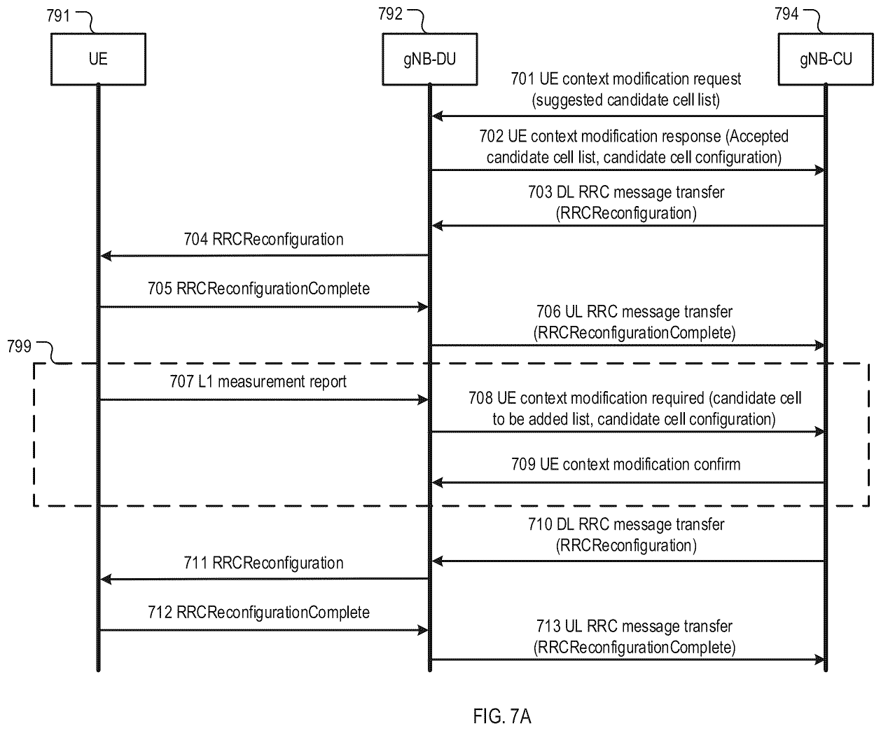

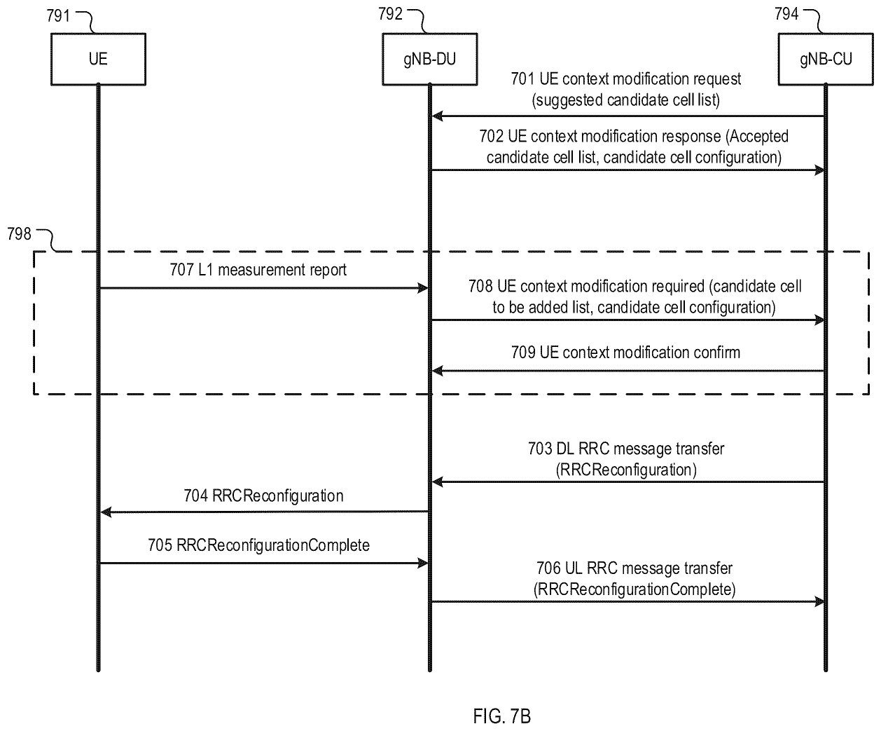

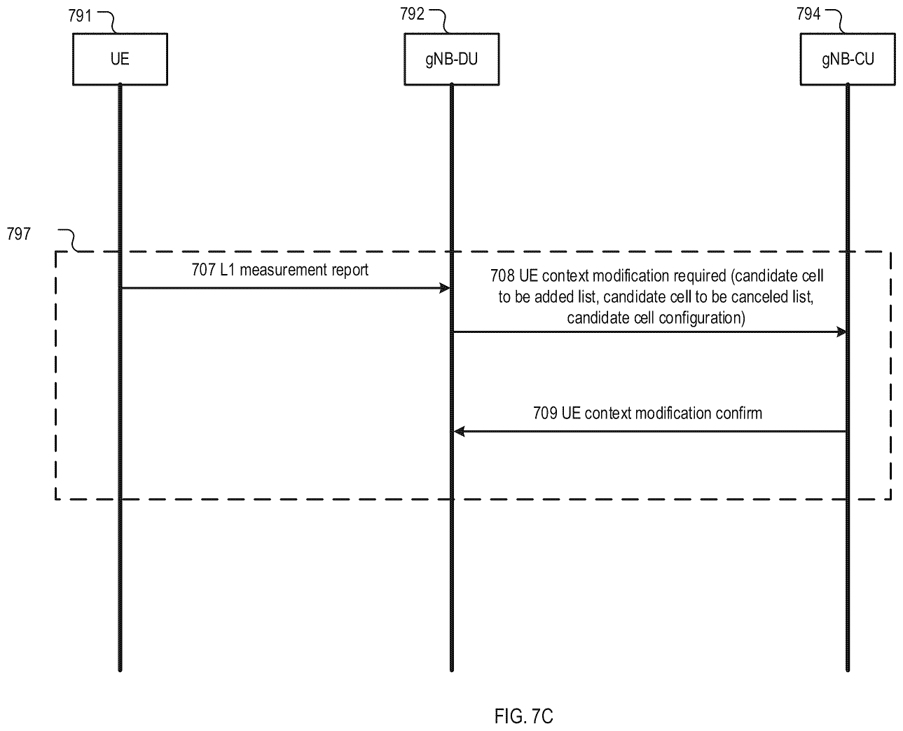

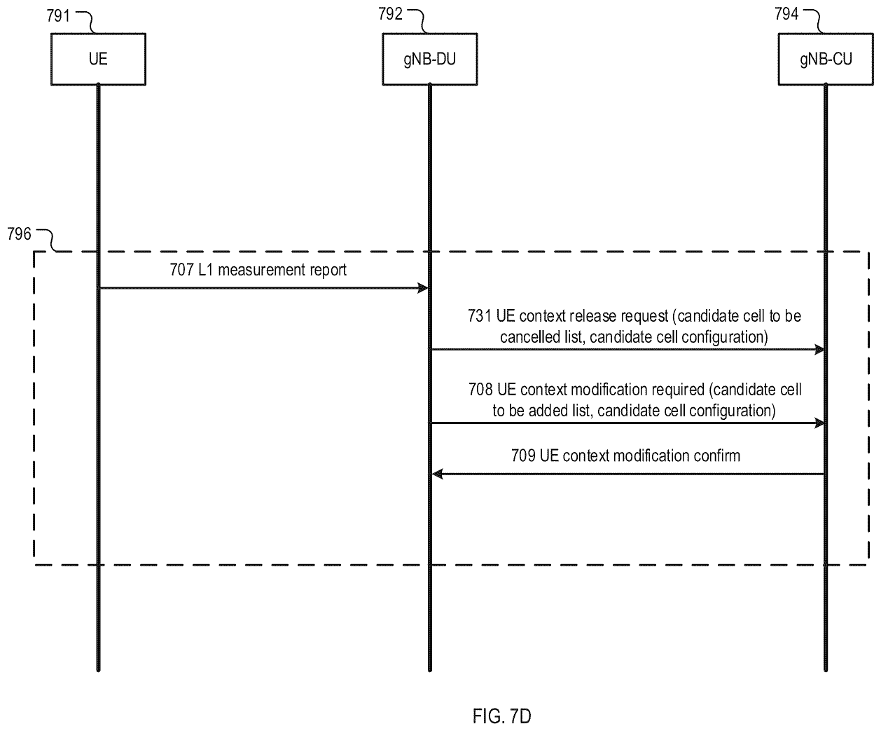

FIG. 7A shows one exemplary embodiment for modifying candidate cells for a L1/L2 based intra-DU inter-cell mobility, wherein a UE 791 may move from first cell(s) operated by a gNB-DU 792 to second cell(s) operated by the same gNB-DU 792. In some implementations, the gNB-DU may communicate with a gNB-CU 794, which can be referred as intra-CU intra-DU inter-cell mobility. The exemplary embodiment may include a portion or all of the following steps. The following steps are labeled with step numbers, which are used for labeling the steps and do not impose any limitation on the order/sequence of the steps.

Steps 701, 702, 703, 704, 705, 706, and 707 may be performed similarly as steps 501, 502, 503, 504, 505, 506, and 507, respectively.

Referring to step 708, the gNB-DU (or referred as “DU”) determines the candidate cell(s) to be added. The DU sends the candidate cell to be added list and the generated candidate cell configuration (e.g. CellGroupConfig) to the gNB-CU (or referred as “CU”) via a F1 interface message (e.g. UE context modification required message or other message).

In some implementations, the F1 interface message may include a UE context modification required message. The UE context modification required message may belong to a class 1 message, which needs the message receiver to send a response message to the message sender. When the CU receives the UE context modification required message from the DU, the CU need to send the DU a response message in response to the UE context modification required message. (see step 709).

Referring to step 709, the CU responds to the DU with a confirmation message (e.g., a UE context modification confirm message).

Steps 710, 711, 712, and 713 may be performed similarly as steps 509, 510, 511, and 512, respectively, which may be similarly performed as steps 503, 504, 505, and 506, respectively.

Steps 707, 708, and 709, referred as 799, describes implementations, wherein the DU determines the to-be-added candidate cell list based on the L1 measurement report received from the UE, the DU sends the to-be-added candidate cell list to the CU via a F1 interface message, and when the F1 interface message is a class 1 message, the CU responds to the DU with a confirmation message.

In some other implementations, referring to FIG. 7B, the steps 707, 708, and 709, referred as 798, may be performed between step 702 and step 703, wherein the DU receives a L1 measurement report from the UE after step 702 and determines the candidate cell(s) to be added, the DU sends the to-be-added candidate cell list to the CU via a F1 interface message, and when the F1 interface message is a class 1 message, the CU responds to the DU with a confirmation message.

In some other implementations, any combination of the following may occur simultaneously: the to-be-canceled candidate cell list corresponding to candidate cell release, the to-be-added candidate list corresponding to candidate cell addition, the suggested candidate cell list, and the like. Below, a combination of the to-be-added candidate cell list and a to-be-canceled candidate cell list is taken as a non-limiting example.

Referring to 797 in FIG. 7C, a single F1 interface message may include the to-be-added candidate cell list and a to-be-canceled candidate cell list. The DU determines the to-be-added candidate cell list and the to-be-canceled candidate cell list based on the L1 measurement report received from the UE, the DU sends the to-be-added candidate cell list and the to-be-canceled candidate cell list to the CU via a F1 interface message, and when the F1 interface message is a class 1 message, the CU responds to the DU with a confirmation message. In various implementations, the 797 may replace either 799 in FIG. 7A or 798 in FIG. 7B.

Referring to 796 in FIG. 7D, two F1 interface messages may be used: one F1 interface message includes the to-be-added candidate cell list; and another F1 interface message includes the to-be-canceled candidate cell list. The DU determines the to-be-added candidate cell list and the to-be-canceled candidate cell list based on the L1 measurement report received from the UE, the DU sends the to-be-added candidate cell list and the to-be-canceled candidate cell list to the CU via two F1 interface messages. For each F1 interface message, depending on whether it's class 1 message or class 2 message, the CU either responds or does not respond to the DU with a confirmation message. For a non-limiting example, in step 731, the DU sends a UE context release request message including the to-be-canceled candidate cell list and/or the generated candidate cell configuration (e.g. CellGroupConfig); and because the UE context release request message is a class 2 message, the CU does not need to respond to it. In some implementations, the order of steps 731 and 708 may be different, for example, step 708 may be performed before step 731. In various implementations, the 796 may replace either 799 in FIG. 7A or 798 in FIG. 7B.

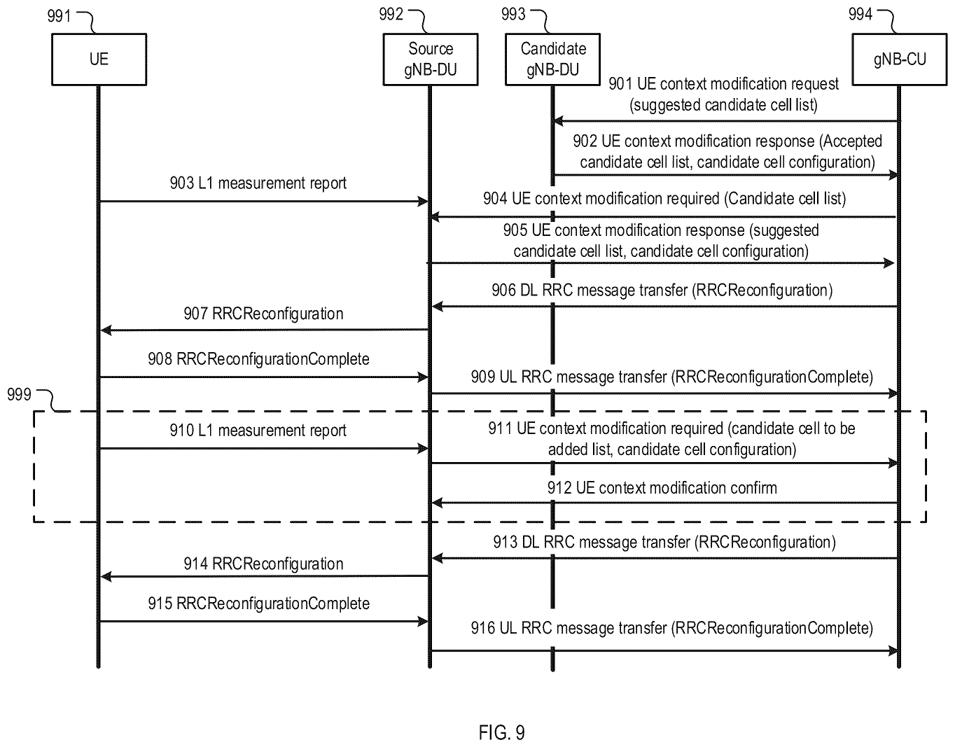

In various embodiments with the inter-DU L1/L2 based inter-cell mobility, the source DU may send the to-be-added candidate cell list and the to-be-canceled candidate cell list to the CU simultaneously or consecutively. For non-limiting examples, the 796 (or 797) may replace one of the following: 699 in FIG. 6A, 698 in FIG. 6B, and/or 999 in FIG. 9.

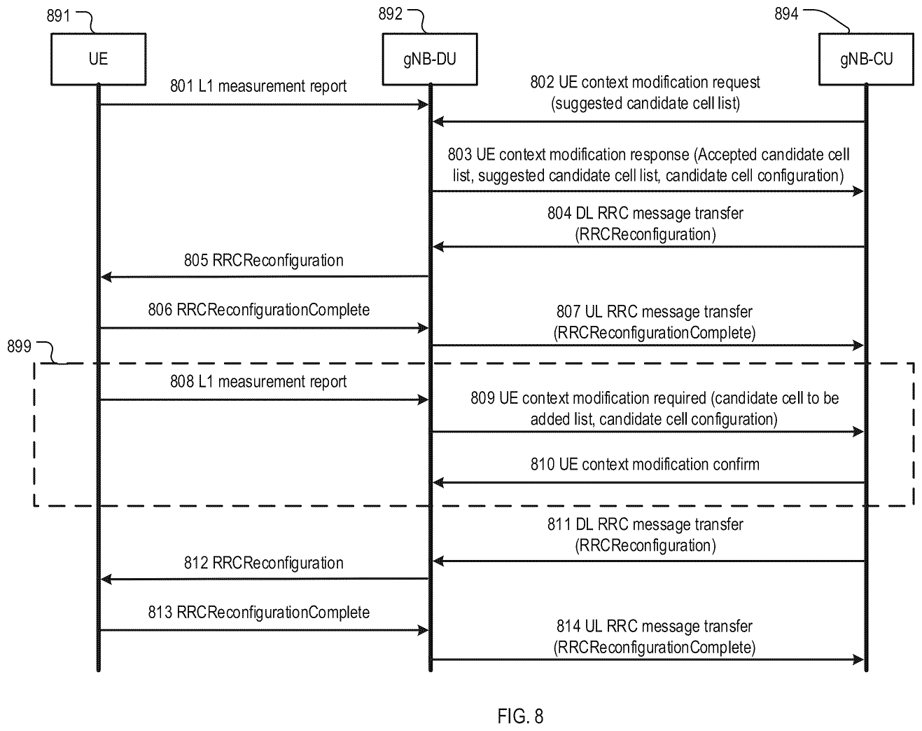

FIG. 8 shows one exemplary embodiment for modifying candidate cells for a L1/L2 based intra-DU inter-cell mobility, wherein a UE 891 may move from first cell(s) operated by a gNB-DU 892 to second cell(s) operated by the same gNB-DU 892. In some implementations, the gNB-DU may communicate with a gNB-CU 894, which can be referred as intra-CU intra-DU inter-cell mobility. The exemplary embodiment may include a portion or all of the following steps. The following steps are labeled with step numbers, which are used for labeling the steps and do not impose any limitation on the order/sequence of the steps.

Referring to step 801, the UE sends a L1 measurement report to the DU. The L1 measurement report may be referred as an initial or first measurement report, and there is another L1 measurement report is sent by the UE to the DU in step 808.

Referring to step 802, the CU determines the candidate cell, e.g. according to the RRM measurements. The CU sends a suggested candidate cell list to the DU via F1 interface message (e.g. UE CONTEXT MODIFICATION REQUEST message or other message), to request DU to set up candidate cells. The message may also include an indication to indicate that the procedure is for L1/L2 mobility, and/or an indication to indicate that the procedure is for which type of L1/L2 mobility.

Referring to step 803, the DU determines whether to set up the candidate cells as CU suggested and determines its suggested candidate cell based on the L1 measurement report, and sends the generated candidate cell configuration (e.g. CellGroupConfig) to the CU, e.g. via UE CONTEXT MODIFICATION RESPONSE message. When the DU fails to set up some candidate cells, DU may also include a accepted cell list (e.g. including a list of cells that have been successfully set up) or a failed/rejected cell list (e.g. including a list of cells that fail to set up) in the message. The DU may also include a suggested cell list based on L1 measurement report. The DU may also include the generated triggering events/execution conditions in the message (e.g. for UE or CU triggered mobility).

Steps 804, 805, 806, 807, 808, 809, 810, 811, 812, 813, and 814 may be performed similarly as steps 703, 704, 705, 706, 707, 708, 709, 711, 712, and 713, respectively.

In 899, in some other implementations, any combination of the following may occur simultaneously: the to-be-canceled candidate cell list corresponding to candidate cell release, the to-be-added candidate list corresponding to candidate cell addition, the suggested candidate cell list, and the like. 797 and 796 may serve as non-limiting examples for 899.

FIG. 9 shows another exemplary embodiment for modifying candidate cells for a L1/L2 based inter-DU inter-cell mobility, wherein a UE 991 may move from a cell operated by a source gNB-DU 992 to another cell operated by a candidate gNB-DU 993. In some implementations, the source gNB-DU and the candidate gNB-DU may communicate with a same gNB-CU 994, which can be referred as intra-CU inter-DU inter-cell mobility. The exemplary embodiment may include a portion or all of the following steps. The following steps are labeled with step numbers, which are used for labeling the steps and do not impose any limitation on the order/sequence of the steps.

Steps 901 and 902 may be performed similarly as steps 601 and 602, respectively.

Referring to step 903, the UE sends a L1 measurement report to the source DU. The L1 measurement report may be referred as an initial or first measurement report, and there is another L1 measurement report is sent by the UE to the DU in step 910.

Step 904 may be performed similarly as step 603.

Referring to step 905, the source DU determines its suggested candidate cell based on the L1 measurement report, and sends the generated candidate cell configuration (e.g. CellGroupConfig) to the CU, e.g. via UE CONTEXT MODIFICATION RESPONSE message. This message may also include the DU generated triggering events/execution conditions (e.g. for UE triggered mobility or CU triggered mobility).

Steps 906, 907, 908, 909, 910, 911, 912, 913, 914, 915, and 916 may be performed similarly as 703, 704, 705, 706, 707, 708, 709, 710, 711, 712, and 713, respectively.

In 999, in some other implementations, any combination of the following may occur simultaneously: the to-be-canceled candidate cell list corresponding to candidate cell release, the to-be-added candidate list corresponding to candidate cell addition, the suggested candidate cell list, and the like. 797 and 796 may serve as non-limiting examples for 999.

The present disclosure describes methods, apparatus, and computer-readable medium for wireless communication. The present disclosure addressed the issues with modifying candidate cells for a L1/L2 based inter-cell mobility. The methods, devices, and computer-readable medium described in the present disclosure may facilitate the performance of wireless communication by modifying candidate cells for a L1/L2 based inter-cell mobility, thus improving efficiency and overall performance. The methods, devices, and computer-readable medium described in the present disclosure may improves the overall efficiency of the wireless communication systems.

Reference throughout this specification to features, advantages, or similar language does not imply that all of the features and advantages that may be realized with the present solution should be or are included in any single implementation thereof. Rather, language referring to the features and advantages is understood to mean that a specific feature, advantage, or characteristic described in connection with an embodiment is included in at least one embodiment of the present solution. Thus, discussions of the features and advantages, and similar language, throughout the specification may, but do not necessarily, refer to the same embodiment.

Furthermore, the described features, advantages and characteristics of the present solution may be combined in any suitable manner in one or more embodiments. One of ordinary skill in the relevant art will recognize, in light of the description herein, that the present solution can be practiced without one or more of the specific features or advantages of a particular embodiment. In other instances, additional features and advantages may be recognized in certain embodiments that may not be present in all embodiments of the present solution.

1. A method for wireless communication, comprising:
modifying, by a first network node, at least one candidate cell (CC) for an inter-cell mobility by:
sending, by the first network node, a CC modification message to a second network node, the CC modification message comprising a modified CC list.

2. (canceled)

3. The method according to claim 1, wherein:
in response to the inter-cell mobility belonging to an intra-distributed unit (intra-DU) inter-cell mobility, the first network node comprises a distributed unit of a base station (gNB-DU);
in response to the inter-cell mobility belonging to an inter-distributed unit (inter-DU) inter-cell mobility, the first network node comprises a source gNB-DU; and
the second network node comprises a control unit of the base station (gNB-CU).

4. The method according to claim 1, wherein:
the inter-cell mobility comprises a layer 1 or layer 2 signaling based mobility (L1/L2 mobility).

5. The method according to claim 1, wherein:
the CC modification message comprises the modified CC list; or
the first network node sends a second message to the second network node, the second message comprising the modified CC list.

6. The method according to claim 1, wherein:
the CC modification message belongs to an F1 interface message; and
the modified CC list comprises at least one of the following: a to-be-cancelled CC list, a to-be-added CC list, a DU-suggested CC list.

7. (canceled)

8. The method according to claim 1, wherein:
the inter-cell mobility belongs to an intra-DU inter-cell mobility;
in response to receiving the CC modification message from the first network node, the second network node sends a modified RRCReconfiguration message to the first network node, the modified RRCReconfiguration message comprising a modified CC configuration based on the modified CC list;
the first network node forwards the modified RRCReconfiguration message to a user equipment (UE); and
the first network receives a modified RRCReconfigurationComplete message from the UE and forwards the modified RRCReconfigurationComplete message to the second network node.

9-14. (canceled)

15. The method according to claim 1, wherein:
the inter-cell mobility belongs to an intra-CU inter-DU inter-cell mobility between the first network node and a third network node;
in response to receiving the CC modification message from the first network node, the second network node sends a modified RRCReconfiguration message to the first network node, the modified RRCReconfiguration message comprising a modified CC configuration based on the modified CC list;
the first network node forwards the modified RRCReconfiguration message to a UE; and
the first network receives a modified RRCReconfigurationComplete message from the UE and forwards the modified RRCReconfigurationComplete message to the second network node.

16-26. (canceled)

27. A first network node comprising:
a memory storing instructions; and
at least one processor in communication with the memory, wherein, when the at least one processor executes the instructions, the at least one processor is configured to cause the first network node to perform:
modifying at least one candidate cell (CC) for an inter-cell mobility by:
sending a CC modification message to a second network node, the CC modification message comprising a modified CC list.

28. The first network node according to claim 27, wherein:
in response to the inter-cell mobility belonging to an intra-distributed unit (intra-DU) inter-cell mobility, the first network node comprises a distributed unit of a base station (gNB-DU);
in response to the inter-cell mobility belonging to an inter-distributed unit (inter-DU) inter-cell mobility, the first network node comprises a source gNB-DU; and
the second network node comprises a control unit of the base station (gNB-CU).

29. The first network node according to claim 27, wherein:
the inter-cell mobility comprises a layer 1 or layer 2 signaling based mobility (L1/L2 mobility).

30. A method for wireless communication, comprising:
supporting, by a second network node, modification of at least one candidate cell (CC) for an inter-cell mobility by:
receiving, by the second network node, a CC modification message from a first network node, the CC modification message comprising a modified CC list.

31. The method according to claim 30, wherein:
in response to the inter-cell mobility belonging to an intra-distributed unit (intra-DU) inter-cell mobility, the first network node comprises a distributed unit of a base station (gNB-DU);
in response to the inter-cell mobility belonging to an inter-distributed unit (inter-DU) inter-cell mobility, the first network node comprises a source gNB-DU; and
the second network node comprises a control unit of the base station (gNB-CU).

32. The method according to claim 30, wherein:
the inter-cell mobility comprises a layer 1 or layer 2 signaling based mobility (L1/L2 mobility).

33. The method according to claim 30, wherein:
the CC modification message comprises the modified CC list; or
the first network node sends a second message to the second network node, the second message comprising the modified CC list.

34. The method according to claim 30, wherein:
the CC modification message belongs to an F1 interface message; and
the modified CC list comprises at least one of the following: a to-be-cancelled CC list, a to-be-added CC list, a DU-suggested CC list.

35. The method according to claim 30, wherein:
the inter-cell mobility belongs to an intra-DU inter-cell mobility;
in response to receiving the CC modification message from the first network node, the second network node sends a modified RRCReconfiguration message to the first network node, the modified RRCReconfiguration message comprising a modified CC configuration based on the modified CC list;
the first network node forwards the modified RRCReconfiguration message to a user equipment (UE); and
the first network receives a modified RRCReconfigurationComplete message from the UE and forwards the modified RRCReconfigurationComplete message to the second network node.

36. The method according to claim 30, wherein:
the inter-cell mobility belongs to an intra-CU inter-DU inter-cell mobility between the first network node and a third network node;
in response to receiving the CC modification message from the first network node, the second network node sends a modified RRCReconfiguration message to the first network node, the modified RRCReconfiguration message comprising a modified CC configuration based on the modified CC list;
the first network node forwards the modified RRCReconfiguration message to a UE; and
the first network receives a modified RRCReconfigurationComplete message from the UE and forwards the modified RRCReconfigurationComplete message to the second network node.

37. An apparatus comprising:
a memory storing instructions; and
at least one processor in communication with the memory, wherein, when the at least one processor executes the instructions, the at least one processor is configured to cause the apparatus to perform:
supporting modification of at least one candidate cell (CC) for an inter-cell mobility by:
receiving a CC modification message from a first network node, the CC modification message comprising a modified CC list.

38. The apparatus according to claim 37, wherein:
in response to the inter-cell mobility belonging to an intra-distributed unit (intra-DU) inter-cell mobility, the first network node comprises a distributed unit of a base station (gNB-DU);
in response to the inter-cell mobility belonging to an inter-distributed unit (inter-DU) inter-cell mobility, the first network node comprises a source gNB-DU; and
the apparatus comprises a control unit of the base station (gNB-CU).

39. The apparatus according to claim 37, wherein:
the inter-cell mobility comprises a layer 1 or layer 2 signaling based mobility (L1/L2 mobility).
